(19) United States
(12) Patent Application Publication
(10) Pub. No.: US 2010/0099582 A1
(43) Pub. Date: Apr. 22, 2010

(54) Biochip Package Structure

(75) Inventors: Chin-Fong Chiu, Hsinchu (TW); Ying-Zong Juang, Hsinchu (TW); Hann-huei Tsai, Hsinchu (TW); Chen-Fu Lin, Hsinchu (TW)

Correspondence Address: Juan Carlos A. Marquez;c/o Stites & Harbison PLLC, 1199 North Fairfax Street, Suite 900, Alexandria, VA, 22314-1437, US

(73) Assignee: National Chip Implementation Center National Applied Research Laboratories, Hsinchu City (TW)

(21) Appl. No.: 12/336,855

(22) Filed: Dec. 17, 2008

(30) Foreign Application Priority Data
Oct. 20, 2008 (TW) 097140214

(51) Int. Cl. C40B 60/12

(52) U.S. Cl. 506/39

(57) ABSTRACT

A biochip package structure is provided. The biochip package structure includes a substrate, a biochip, at least one wire, and a molding compound. The substrate has a circuit unit electrically connected, by wiring, to the biochip defined with a sensing region. The molding compound covers the wire but leaves the sensing region of the biochip exposed, allowing a cavity to be formed in the sensing region. The cavity delivers a biomedical sample. The biomedical sample reacts in the sensing region. Thus, the biochip package structure is applicable to various medical and biochemical assays.

### BACKGROUND OF THE INVENTION

1. Technical Field

The present invention relates to a biochip package structure, and more particularly, to a biochip package structure capable of delivering a biomedical sample to a biochip therein.

2. Description of Related Art

A biochip refers to a bioassay element, based on principles of molecular biology and biochemistry, having a substrate made of glass or polymer materials, and incorporating therewith the micro-electro-mechanical technology. Such biochip features for its compact size as well as excellent ability in prompt and parallel processing and thus allows a large scale of bioassay to be accomplished in a minute area. A micro-fluidic channel provided on such biochip accommodates procedures for processing a biomedical sample, such as mixing, transmitting and segregating. By using a biochip having a micro-fluidic channel, advantages, including reducing experimental errors owing to human operation, minimizing consumption of energy and biomedical samples, and saving labor as well as time, can be achieved.

FIG. 1 is a cross-sectional view of a conventional biochip package structure having a micro-fluidic channel.

Referring to FIG. 1, a conventional biochip package structure is constructed by steps of using a polymer material to build a three-dimensional rail 21 and adhering the rail 21 onto a biochip 10 so as to form a micro-fluidic channel 20 on the biochip 10. Besides the area occupied by the rail 21, the biochip 10 has to reserve area for the dispensing process where a molding compound 30 is formed on the biochip 10. Consequently, the effective area of the biochip 10 is significantly limited and thus the overall working efficiency of the biochip 10 is adversely affected.

The prefabricated rail 21, for convenient attachment to the biochip 10, is sized according to the biochip 10 and thus provides a relatively limited capacity for accommodating biomedical samples. Consequently, due to insufficiency of the biomedical sample in the micro-fluidic channel 20, the biochip 10 is likely to give inaccurate testing results.

Besides, electronic packaging effect of the biochip 10 provided by the molding compound 30 formed through the dispensing process is relatively inferior. Hence, there is a need for an approach that forms the micro-fluidic channel 20 on the biochip 10 with maximized effective area and improved electronic packaging effect of the biochip 10, so as to further expand applications of the biochip 10.

### SUMMARY OF THE INVENTION

The present invention discloses a biochip package structure, wherein a micro-fluidic channel is formed on a biochip, and an increased contacting area between the micro-fluidic channel and the biochip is provided, thereby enhancing overall working efficiency of the biochip.

The present invention also discloses a biochip package structure, which has a cavity for delivering a biomedical sample so as to easily control consumption of the biomedical sample.

To achieve these and other objectives of the present invention, the disclosed biochip package structure includes a substrate with a circuit unit, a biochip coupled to the substrate and defined with at lease one sensing region, at least one wire electrically connecting the circuit unit and the biochip, and a molding compound for covering the wire but leaving the sensing region exposed so as to form a cavity in the sensing region.

By implementing the present invention, at least the following progressive effects can be achieved:

1. The relatively large contacting area between the biochip and a biomedical sample delivered thereon improves overall working efficiency of the biochip.

2. The cavity is capable of delivering the biomedical sample in a relatively large amount and therefore conducive to accurate bioassay results.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a cross-sectional view of a conventional biochip package structure having a micro-fluidic channel;

FIG. 2 is an exploded view of a biochip package structure according to a first embodiment of the present invention;

FIG. 3 is an assembled perspective view of the biochip package structure of FIG. 2;

FIG. 4 is a cross-sectional view taken along line A-A of FIG. 3;

FIG. 5A is a cross-sectional view of the biochip package structure according to one aspect of the first embodiment of the present invention;

FIG. 5B is a cross-sectional view of the biochip package structure according to another aspect of the first embodiment of the present invention;

FIG. 6A is an exploded view of a biochip package structure according to a second embodiment of the present invention;

FIG. 6B is an assembled perspective view of the biochip package structure of FIG. 6A;

FIG. 7A is a cross-sectional view taken along line B-B of FIG. 6B;

FIG. 7B is an applied view of the biochip package structure of FIG. 7A;

FIG. 8A is a cross-sectional view of the biochip package structure according to another aspect of the present invention; and

FIG. 8B is an applied view of the biochip package structure of FIG. 8A.

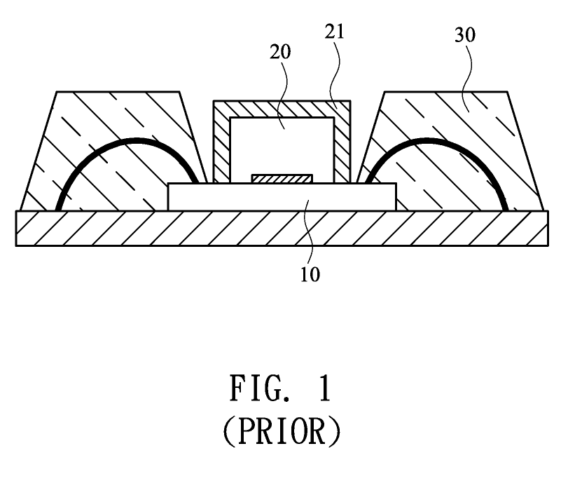

### DETAILED DESCRIPTION OF THE PREFERRED EMBODIMENTS

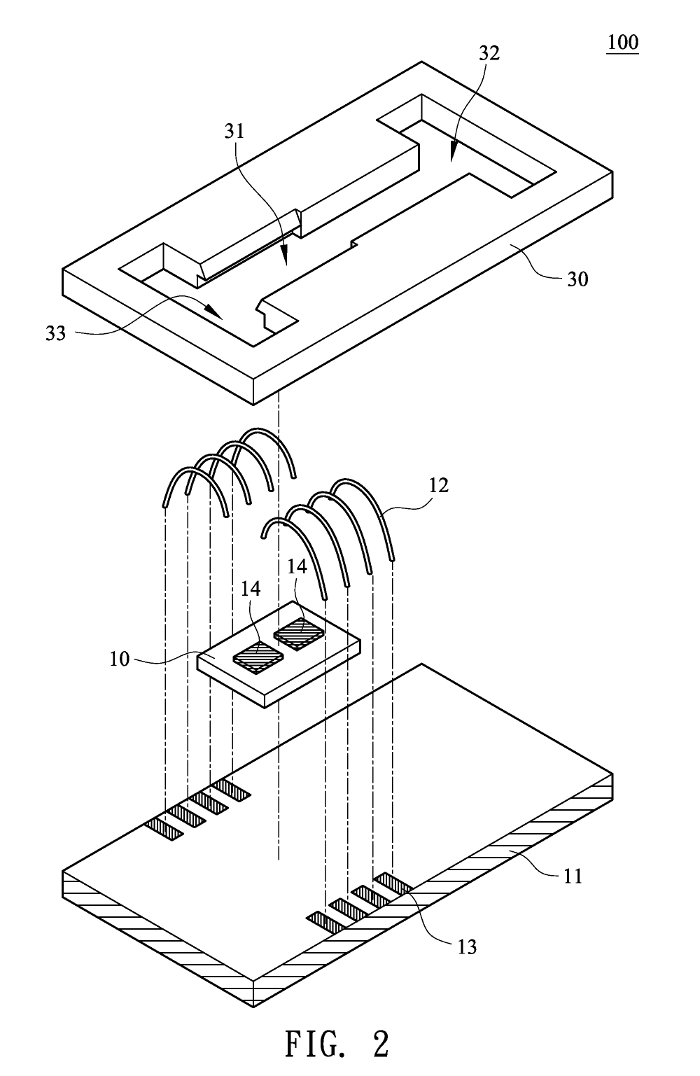

Referring to FIG. 2, the present embodiment relates to a biochip package structure 100, which includes a substrate 11, a biochip 10, at least one wire 12, and a molding compound 30.

The substrate 11 is formed with a circuit unit 13. The substrate 11 may be a circuit board, a glass substrate, or a substrate made of LTCC (Low-Temperature Cofired Ceramics), a biocompatible material or other materials meeting required circuit characteristics.

The biochip 10 is coupled to the substrate 11 and defined with at lease one sensing region 14. The biochip 10 is a chip applicable to bioassay for medical or biochemical purposes. For instance, by using the micro-electro-mechanical technology, a CMOS (Complementary Metal-Oxide-Semiconductor) may be equipped with at least one said sensing region 14 made of metal so as to allow bio-molecules to be bound and fixed by the sensing region 14, thereby permitting bioassay on the bio-molecules. Functions of the sensing region 14 on the biochip 10 may include reading genetic sequence, analyzing protein composition, measuring pH, etc.

The wire 12 electrically connects the circuit unit 13 of the substrate 11 and the biochip 10. The wire 12 is made of gold, aluminum, copper or alloy thereof.

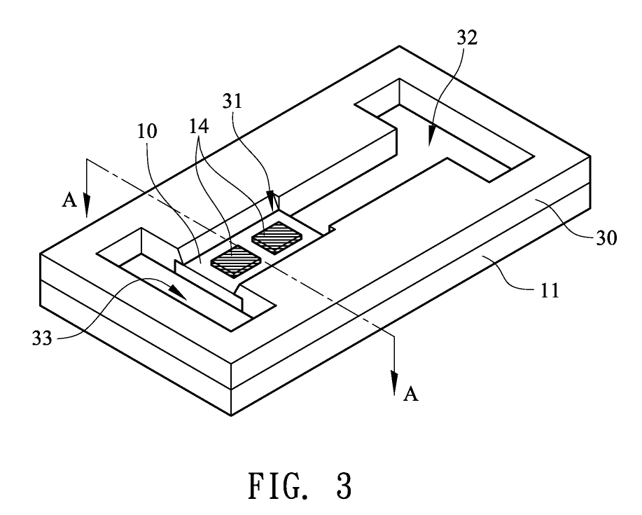

As shown in FIGS. 2 and 3, the molding compound 30 covers each said wire 12 but leaves the sensing region 14 exposed so as to form a cavity 31 in the sensing region 14. The molding compound 30 is made of epoxy resin or other materials generally used for IC package. Also, the molding compound 30 is formed by an injection molding process so as to enhance packaging efficiency of the biochip package structure 100. Moreover, an input hole 32 and an output hole 33 are formed at two ends of the cavity 31, respectively.

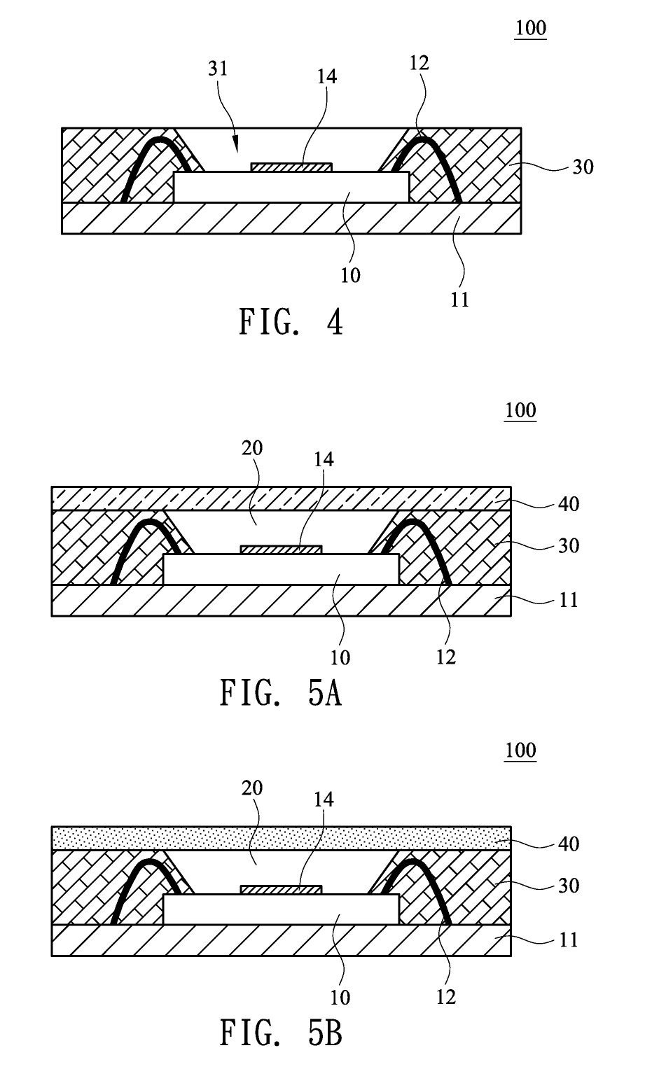

Referring to FIG. 4, the exposed sensing region 14 is configured to be in direct contact with a biomedical sample thereon. Therefore, upon passage of a biomedical sample through the cavity 31, the sensing region 14 reacts with the biomedical sample. The wire 12 connecting the biochip 10 and the substrate 11 is covered by the molding compound 30 and thus is protected from being damaged by moisture.

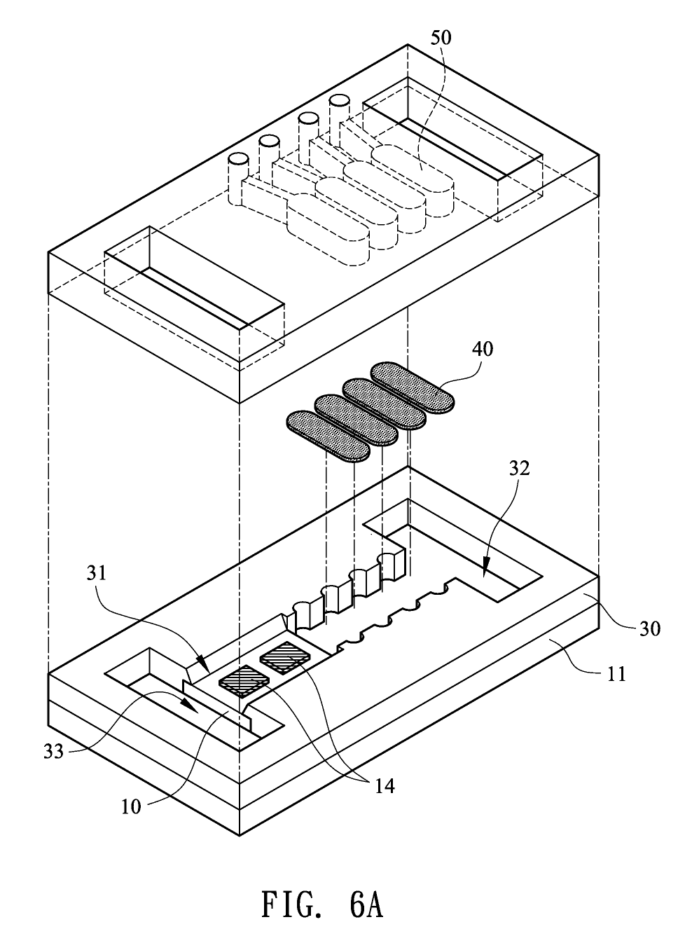

Referring to FIG. 5A, the biochip package structure 100 further includes a cover 40 fixed in position to the molding compound 30 and facing the biochip 10. Since the cover 40 fully covers the cavity 31, a micro-fluidic channel 20 is formed in the biochip package structure 100.

Referring to FIG. 5A again, the cover 40 is made of a material that is penetrable to light so that the biochip package structure 100 is allowed to be used with an optical inspection system, such as, for analyses of fluorescent labels.

Alternatively, as shown in FIG. 5B, the cover 40 is made of a material that is impenetrable to light. After flowing into the biochip package structure 100 through the input hole 32, the biomedical sample is led to the sensing region 14 of the biochip 10 and eventually leaves the biochip 10 at the output hole 33. The cover 40 is made of a biocompatible material, such as polydimethylsiloxane (PDMS) or polymethylmethacrylate (PMMA). Optionally, a material of which the cover 40 is made is flexible too.

Regarding the micro-fluidic channel 20 defined by the cover 40 of the biochip package structure 100, the micro-fluidic channel 20 is capable of accommodating obviously a larger amount of a biomedical sample than that receivable in a micro-fluidic channel 20 of a conventional biochip package structure. Hence the accuracy of bioassay results obtained through the biochip package structure 100 of the present invention is improved, thereby avoiding erroneous determination. Meanwhile, consumption of the biomedical sample can be easily controlled.

Unlike a conventional cover 40 which is in contact with a micro-fluidic channel 20 of a biochip 10 and thus reduces the effective area of the biochip 10, the cover 40 of the present invention is fixed upon the molding compound 30 without contacting the biochip 10. Consequently, the micro-fluidic channel 20 defined by the cover 40 facilitates maximizing the effective area of the biochip 10 and thus enhancing the overall working efficiency of the biochip 10.

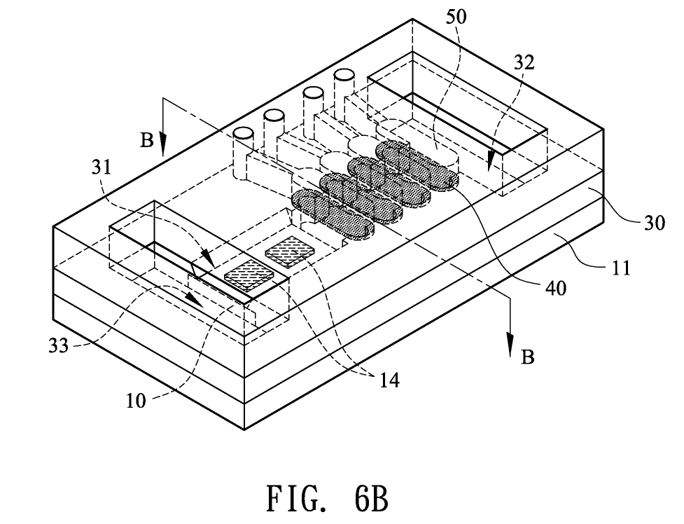

Referring now to FIGS. 6A and 6B, the biochip package structure 100 further comprises a micro-fluidics driving unit 50 attached to the cover 40 and configured to adjust flow rate of the biomedical sample introduced into the micro-fluidic channel 20 so as to allow the biomedical sample to pass through the sensing region 14 of the biochip 10 with a constant flow rate. Particularly, the micro-fluidics driving unit 50 is a pneumatic micro-pump 501.

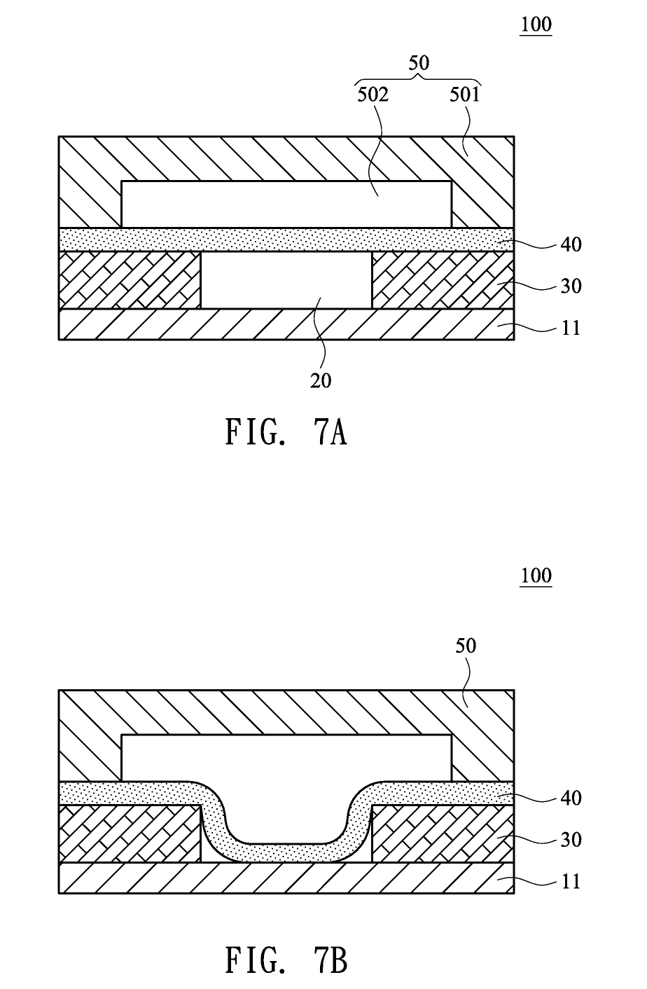

Referring to FIG. 7A, the pneumatic micro-pump 501 is attached to the cover 40 to form a high-pressure gas channel 502. Referring to FIG. 7B, since the cover 40 is flexible, when the high-pressure gas channel 502 is fed with gas, the cover 40 sags under the gas pressure and thereby stops the biomedical sample in the micro-fluidic channel 20 below the cover 40 from flowing. After the gas passes the high-pressure gas channel 502, the cover 40 recovers its initial status and therefore the biomedical sample in the micro-fluidic channel 20 is allowed to flow forward again. By using the pneumatic micro-pump 501, it is possible to adjust gas pressure in the high-pressure gas channel 502 or the frequency where the gas passes through the high-pressure gas channel 502 in order to control the frequency of sagging of the cover 40 and thus push the biomedical sample forward, thereby controlling the flow rate of the biomedical sample in the micro-fluidic channel 20.

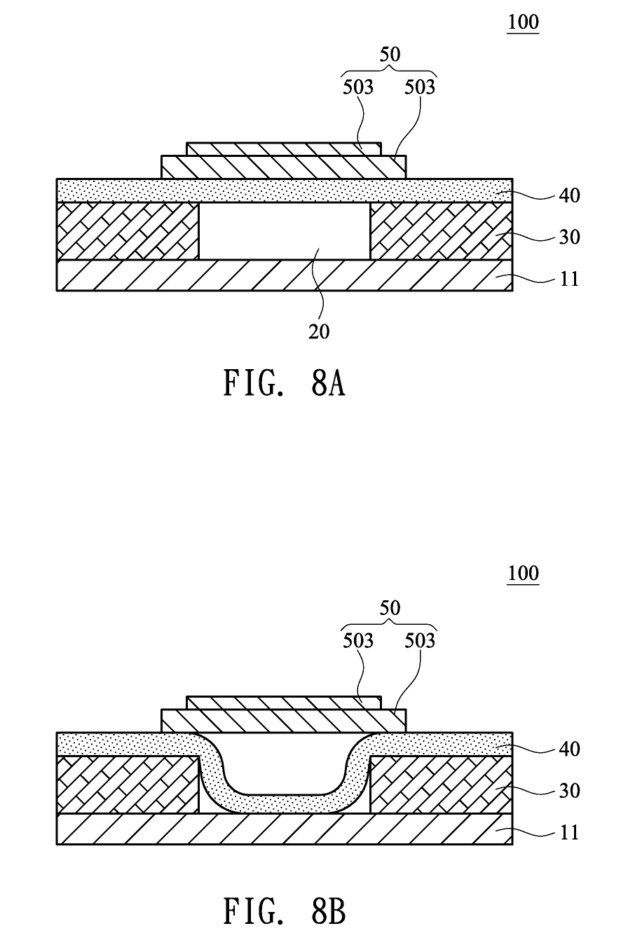

Referring to FIG. 8A, alternatively, the micro-fluidics driving unit 50 is a piezoelectric micro-pump 503 that includes a piezoelectric actuator and is attached to the cover 40 by means of, for example, a peripheral fixing manner.

By adjusting electric field strength of the piezoelectric micro-pump 503, the cover 40 sags under the control of the piezoelectric micro-pump 503, as shown in FIG. 8B, and in turn varies inner space of the micro-fluidic channel 20. Similarly, the piezoelectric micro-pump 503 also serves to bulge the cover 40 (not shown).

Therefore, by using the piezoelectric micro-pump 503, it is possible to adjust the flow rate of the biomedical sample in the micro-fluidic channel 20 and thus distribute the biomedical sample in the micro-fluidic channel 20 more evenly.

Although the particular embodiments of the invention have been described in detail for purposes of illustration, it will be understood by one of ordinary skill in the art that numerous variations will be possible to the disclosed embodiment without going outside the scope of the invention as disclosed in the claims.

What is claimed is:

1. A biochip package structure, comprising:
a substrate with a circuit unit;
a biochip coupled to the substrate and defined with at lease one sensing region;
at least one wire electrically connecting the circuit unit and the biochip; and
a molding compound for covering the wire but leaving the sensing region expose so as to form a cavity in the sensing region.

2. The biochip package structure of claim 1, further comprising a cover facing the biochip and fixed in position to the molding compound to fully cover the cavity and form a micro-fluidic channel.

3. The biochip package structure of claim 2, wherein the cover is made of a biocompatible material.

4. The biochip package structure of claim 2, wherein the cover is made of a material penetrable to light.

5. The biochip package structure of claim 2, wherein the cover is made of a material impenetrable to light.

6. The biochip package structure of claim 2, wherein the cover is flexible.

7. The biochip package structure of claim 6, further comprising a micro-fluidics driving unit attached to the cover.

8. The biochip package structure of claim 7, wherein the micro-fluidics driving unit is a pneumatic micro-pump.

9. The biochip package structure of claim 7, wherein the micro-fluidics driving unit is a piezoelectric micro-pump.
